(19) United States
(12) Patent Application Publication
(10) Pub. No.: US 2012/0050775 A1
(43) Pub. Date: Mar. 1, 2012

(54) IMAGE DELIVERY SYSTEM, IMAGE FORMING APPARATUS, AND DELIVERY MANAGEMENT APPARATUS

(76) Inventor: Hiroshi KAMIMOTO, Kanagawa (JP)

(21) Appl. No.: 13/196,195

(22) Filed: Aug. 2, 2011

(30) Foreign Application Priority Data
Aug. 24, 2010 (JP) 2010-186825

(51) Int. Cl. G06K 15/00

(52) U.S. Cl. 358/1.13

(57) ABSTRACT

An image forming apparatus that delivers an image of a document, the image forming apparatus including a registration-information acquiring unit that acquires registration information that is to be registered in an image management apparatus together with the image of the document; a delivery-allowability determining unit that determines whether delivery of the image of the document is allowable by using the registration information and registration information on the image of the document that is input by a user; a scanning unit that scans a document so as to generate an image of the document if it is determined that delivery of the image of the document is allowed; and a delivery control unit that delivers, to the image management apparatus, the image of the document generated by the scanning unit and the registration information input by the user.

### CROSS-REFERENCE TO RELATED APPLICATIONS

The present application claims priority to and incorporates by reference the entire contents of Japanese Patent Application No. 2010-186825 filed in Japan on Aug. 24, 2010.

### BACKGROUND OF THE INVENTION

1. Field of the Invention

The present invention relates to an image delivery system and, more particularly, to an image delivery system, an image forming apparatus, an information processing apparatus, a method, a program, and a recording medium that manage the delivery of an image of a document that is generated by the image forming apparatus.

2. Description of the Related Art

In a conventional image delivery system, a document, such as a paper document, is scanned by an image forming apparatus, such as a multi-function peripheral (MFP), so as to generate an image of the document, and the document image can be delivered to a file server in which the document image is registered. In such an image delivery system, a file server can perform searches for a registered document image by using key information that identifies a document image transmitted from a user terminal. A user can find a target document image by using key information that identifies the document image and then perform various operations such as viewing, printing, or changing the document image.

Such an image delivery system is disclosed in Japanese Patent Application Laid-open No. 2008-97586. The image delivery system includes an information processing apparatus that sets bibliographic information, which is attribute information on a document image, and performs a process that is related to the bibliographic information. In this image delivery system, a delivery server can register a document image in a file server by performing the process that is related to the bibliographic information.

In the image delivery system disclosed in Japanese Patent Application Laid-open No. 2008-97586, when a document image is registered in the file server, key information that is necessary to search for the registered document image is sometimes not registered. In this case, a user of the image delivery system cannot find a document image for which key information is not registered during a searching operation; therefore, there is a problem in that it is difficult to perform an operation such as viewing, printing, or updating a document image.

### SUMMARY OF THE INVENTION

It is an object of the present invention to at least partially solve the problems in the conventional technology.

An image forming apparatus that delivers an image of a document, the image forming apparatus including a registration-information acquiring unit that acquires registration information that is to be registered in an image management apparatus together with the image of the document; a delivery-allowability determining unit that determines whether delivery of the image of the document is allowable by using the registration information and registration information on the image of the document that is input by a user; a scanning unit that scans a document so as to generate an image of the document if it is determined that delivery of the image of the document is allowed; and a delivery control unit that delivers, to the image management apparatus, the image of the document generated by the scanning unit and the registration information input by the user.

An image delivery system including an image forming apparatus that delivers an image of a document; and an image management apparatus that registers an image of a document that is delivered by the image forming apparatus, the image forming apparatus including a registration-information acquiring unit that acquires registration information that is to be registered in the image management apparatus together with the image of the document; a delivery-allowability determining unit that determines whether delivery of the image of the document is allowable by using the registration information and registration information on the image of the document that is input by a user; a scanning unit that scans a document so as to generate an image of the document if it is determined that delivery of the image of the document is allowed; and a delivery control unit that delivers, to the image management apparatus, the image of the document generated by the scanning unit and the registration information input by the user, and the image management apparatus including a registration control unit that provides the registration information; and a registration unit that registers the image of the document and the registration information input by the user.

A delivery management apparatus that manages delivery of an image of a document that is generated by an image forming apparatus, the delivery management apparatus including: a registration-information acquiring unit that acquires registration information that needs to be registered in an image management apparatus together with the image of the document; a delivery-allowability determining unit that determines whether delivery of the image of the document is allowable by using the registration information and registration information on the image of the document that is input by a user by using the image forming apparatus; and a communication control unit that notifies, if it is determined that the delivery of the image of the document is allowed, the image forming apparatus that the delivery of the image of the document is allowed. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view of an image delivery system according to the present embodiment;

FIG. 2 is a diagram that illustrates the functional configuration of an image forming apparatus and an image management server included in the image delivery system according to the present embodiment;

FIG. 3 is a flowchart of a process performed by the image forming apparatus according to the present embodiment;

FIG. 4 illustrates an embodiment of a registration-information data table that is registered in a registration-information database according to the present embodiment;

FIG. 5 is a representation that illustrates an embodiment of a document-image data table that is registered in a document-image database according to the present embodiment;

FIG. 6 is a diagram that illustrates a registration-information entry screen that is a UI displayed on the image forming apparatus according to the present embodiment;

FIG. 7 is a diagram that illustrates an image delivery system according to another embodiment;

FIG. 8 is a diagram that illustrates the functional configuration of an image forming apparatus, an image management server, and a delivery management server included in the image delivery system illustrated in FIG. 7;

FIG. 9 is a diagram that illustrates a flowchart of a process performed by a delivery management server according to another embodiment; and

FIG. 10 is a diagram that illustrates a flowchart of a process performed by an image forming apparatus according to another embodiment.

### DETAILED DESCRIPTION OF THE PREFERRED EMBODIMENTS

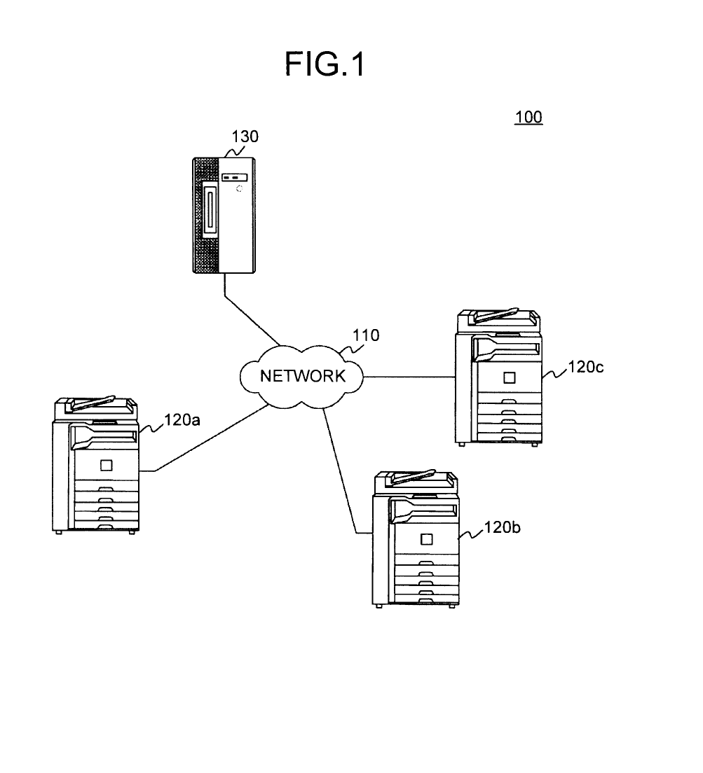

Exemplary embodiments of the present invention are explained in detail below with reference to the accompanying drawings. The present invention is not limited to the embodiments described below. FIG. 1 is a schematic view of an image delivery system 100 according to the present embodiment. The image delivery system 100 includes a network 110, image forming apparatuses 120a, 120b, and 120c, and an image management server 130. The image forming apparatuses 120a, 120b, and 120c, and the image management server 130 are connected to the network 110. The network 110 is configured as, for example, a network that uses Ethernet (registered trademark) and TCP/IP protocol. The network 110 can be implemented as a local area network (LAN).

The image forming apparatuses 120a, 120b, and 120c are configured as image forming apparatuses, such as multi function peripherals (MFPs), that each include a scanner device including a charge coupled device (CCD) sensor, and the like. The image forming apparatuses 120a, 120b, and 120c deliver, to the image management server 130 via the network 110, image data that is read by using the built-in scanner device. The image forming apparatuses 120a, 120b, and 120c each perform the program according to the present embodiment and provide a user interface (hereafter, referred to as a UI) that is displayed on an operation panel, or the like, included in the image forming apparatus.

If the image forming apparatuses 120a, 120b, and 120c are installed as MFPs, the image forming apparatuses 120a, 120b, and 120c each include a processor, RAM, hard disk drive (HDD), and the like, and execute a program that is according to the present embodiment and is described in a programming language, such as Assembler, C, C++, JAVA (registered trademark), or Java (registered trademark) Script, under the control of an OS, such as UNIX (registered trademark) or LINUX (registered trademark) so that the functions described below are performed by the image forming apparatuses. The image delivery system according to the present embodiment includes, for example, three image forming apparatuses; however, in another embodiment, the image delivery system may include any number of image forming apparatuses.

The image management server 130 is a server that registers images of documents (document images) that are delivered by the image forming apparatuses 120a, 120b, and 120c. The image management server 130 is configured as a file server that stores and manages the document images. The image delivery system according to the present embodiment is made up of the single image management server 130; however, in another embodiment, the image delivery system may include a plurality of servers.

The image management server 130 uses a structured document, which is received via the network 110 from an administrative terminal (not illustrated) and is described in a markup language, such as HTML, XML, or XHTML, to update registration information in a database of the image management server 130.

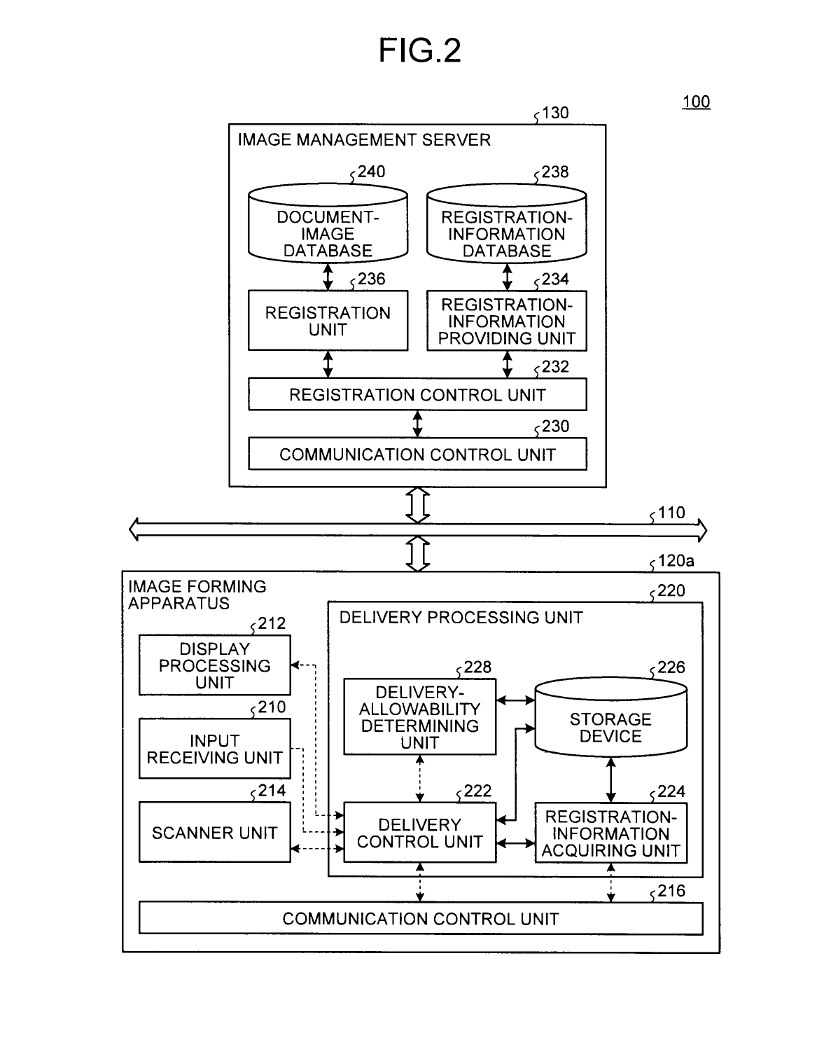

FIG. 2 is a diagram that illustrates the functional configuration of the image forming apparatus 120a and the image management server 130 included in the image delivery system 100 according to the present embodiment. An explanation is given below, with reference to FIG. 2, of the processing function performed by the image forming apparatus 120a and the image management server 130. Because the image forming apparatuses 120b and 120c perform the similar function as the image forming apparatus 120a, their detailed explanations are omitted below.

The image forming apparatus 120a includes an input receiving unit 210, a display processing unit 212, a scanner unit 214, a communication control unit 216, and a delivery processing unit 220.

The input receiving unit 210 is a functional unit that notifies the delivery processing unit 220 of various commands that are generated when a user operates a UI displayed on the operation panel of the image forming apparatus 120a. The input receiving unit 210 gives notice of a request to display a registration-information entry screen that is a UI used for inputting registration information on a document image, completion of entry of the registration information, and an instruction to execute a delivery process.

The input receiving unit 210 gives notice of document-image type information as well as a request to display the registration-information entry screen. According to the present embodiment, a UI on which the document-image type information is selectable is displayed on the operation panel and the document-image type information on a document image to be registered is selected by a user so that the input receiving unit 210 can obtain the document-image type information. The input receiving unit 210 notifies a delivery control unit 222 of the registration information that is input by a user by using the registration-information entry screen as well as the completion of the entry of the registration information.

The display processing unit 212 is a functional unit that displays a UI on the operation panel of the image forming apparatus 120a. According to the present embodiment, the UI displayed by the display processing unit 212 includes a UI used for designating a destination where a document image is to be delivered and includes the registration-information entry screen. The display processing unit 212 displays, on a UI, a file path that is information on a destination where a document image is to be delivered and that indicates a storage destination in a file server.

In the present embodiment, the UI used for designating a destination where a document image is to be delivered is displayed on the operation panel. A user designates the delivery-destination information on the document image and the document-image type information by using the UI displayed on the operation panel and issues a request to display the registration-information entry screen. Then, the input receiving unit 210 notifies the delivery control unit 222 of the request to display the registration-information entry screen and the document-image type information.

The scanner unit 214 is a functional unit that executes a scanning process so as to generate a document image to be registered in the image management server 130. When receiving a command to execute the scanning process from the delivery processing unit 220, the scanner unit 214 causes the scanner device (not illustrated) included in the image forming apparatus 120a to scan a document, performs image correction processes, such as level correction, gamma correction, and edge treatment, and performs A/D conversion so as to generate a document image.

The communication control unit 216 is a functional unit that transmits and receives data between the image forming apparatus 120a and the image management server 130 via the network 110. The communication control unit 216 processes various types of data with respect to the process for delivering a document image and the process for acquiring registration information, which are described later.

In the present embodiment, data transmitted and received via the network 110 includes information used for identifying a destination and a source. The image forming apparatuses 120a, 120b, and 120c and the image management server 130, which are nodes of the network 110, can determine the source of received data.

The delivery processing unit 220 is a functional unit that performs a delivery process to deliver a document image to the image management server 130 via the network 110. The delivery processing unit 220 includes the delivery control unit 222, a registration-information acquiring unit 224, a storage device 226 that stores registration information, and a delivery-allowability determining unit 228.

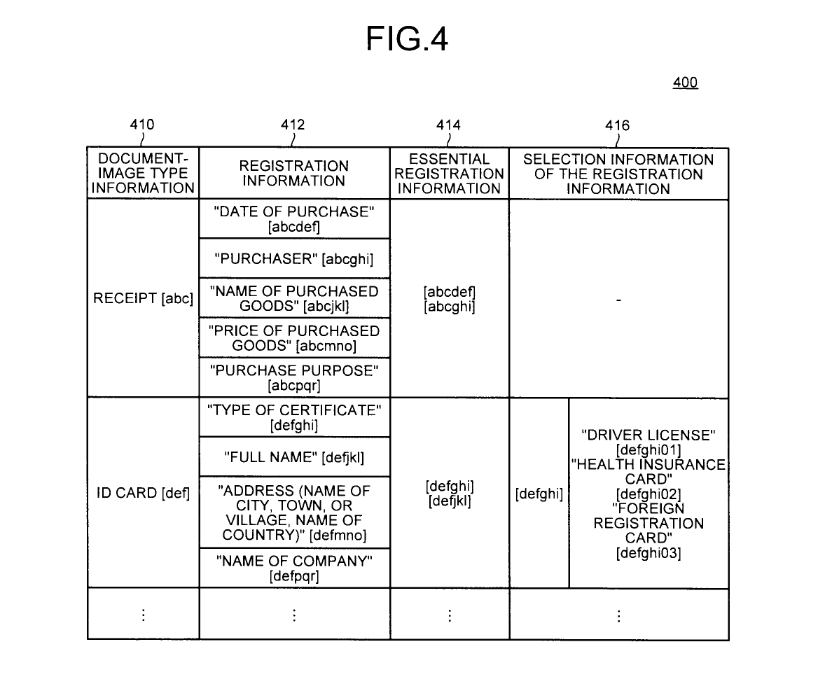

The delivery control unit 222 is a functional unit that controls the functional units included in the delivery processing unit 220, the display processing unit 212, and the scanner unit 214 so as to perform the process for delivering a document image. When receiving, from the input receiving unit 210, a request to display the registration-information screen that is a UI used for inputting registration information, the delivery control unit 222 sends, to the registration-information acquiring unit 224, information that indicates the type of document image to be registered (hereafter, referred to as document-image type information) so as to acquire, from the image management server 130, registration information, essential registration information, and/or selection information of the registration information. The delivery control unit 222 then provides the display processing unit 212 with the registration information, the essential registration information, and/or the selection information of the registration information so that the registration-information entry screen is displayed. A detailed explanation is given later, with reference to FIG. 4, of the registration information, the essential registration information, and the selection information of the registration information.

Upon receiving, from the input receiving unit 210, an event that indicates the input of registration information when the user inputs the registration information on the registration-information entry screen, the delivery control unit 222 causes the delivery-allowability determining unit 228 to determine whether delivery of the document image is allowable. Conversely, upon receiving an event that commands the execution of the delivery process, the delivery control unit 222 causes the scanner unit 214 to scan a document so as to generate a document image and delivers the document image to the image management server 130.

According to the present embodiment, the user presses the execution button for the delivery process that is included in the registration-information entry screen so that the input receiving unit 210 issues the event that commands the execution of the delivery process. In another embodiment, a configuration may be such that, after registration information is input, a screen through which the user can command the execution of the delivery process is displayed by the display processing unit 212 and a request to execute the delivery process is received.

The registration-information acquiring unit 224 is a functional unit that acquires, from the image management server 130, registration information that needs to be registered together with a document image. When receiving a request to acquire registration information from the delivery control unit 222, the registration-information acquiring unit 224 sends, to the image management server 130, the document-image type information that has been received together with the acquisition request (the request to acquire registration information) and sends a request to acquire registration information so as to acquire the registration information, essential registration information, and/or selection information of the registration information from a registration-information database 238 of the image management server 130. The registration-information acquiring unit 224 stores, in the storage device 226, the registration information, the essential registration information, and/or the selection information of the registration information.

According to the present embodiment, the storage device 226 stores the registration information, the essential registration information, and/or the selection information of the registration information, which are acquired from the image management server 130, such that they are related to the document-image type information.

The delivery-allowability determining unit 228 is a functional unit that determines whether a document image can be delivered to the image management server 130. When being called by the delivery control unit 222, the delivery-allowability determining unit 228 acquires the registration information and the essential registration information from the storage device 226 by using the document-image type information that indicates a document image that is a target of a delivery request and determines whether the essential registration information has been input through the registration-information entry screen. The delivery-allowability determining unit 228 stores a result of the determination, as delivery status information that indicates whether the delivery of the document image is allowable, in a memory region that can be referenced by the other functional units, such as the delivery control unit 222.

The image management server 130 includes a communication control unit 230, a registration control unit 232, a registration-information providing unit 234, a registration unit 236, the registration-information database 238, and a document-image database 240.

The communication control unit 230 is a functional unit that transmits and receives data to and from the image management server 130 and the image forming apparatus 120a via the network 110. The communication control unit 230 provides the registration control unit 232 with various types of data related to a process for registering a document image and a process for providing registration information, or transmits the same to the image forming apparatus 120a. Information that indicates a process to be executed is attached to the header of data received by the communication control unit 230. The communication control unit 230 determines a process to be executed by using the header so as to send a document image, registration information, or a request to acquire registration information to the registration control unit 232, or provide the image forming apparatus with registration information via the network 110.

The registration control unit 232 is a functional unit that controls the registration-information providing unit 234 and the registration unit 236 so as to execute a process for registering a document image and a process for providing registration information. When receiving a request to provide registration information from the image forming apparatus, the registration control unit 232 sends the document-image type information to the registration-information providing unit 234 so as to cause the registration-information providing to acquire the registration information from the registration-information database 238 and provides the registration information for the image forming apparatus that has transmitted the request to provide the registration information. When receiving a request to register a document image from the image forming apparatus 120a, the registration control unit 232 sends the document image and the registration information to the registration unit 236 for registration.

The registration-information providing unit 234 is a functional unit that provides the image forming apparatus with registration information. When receiving, from the image forming apparatus 120a, a request to provide registration information and the document-image type information, the registration-information providing unit 234 refers to the registration-information database 238, acquires the registration information that is related to the document-image type information, and then sends the registration information to the registration control unit 232. A detailed explanation is given later of the registration-information database 238.

The registration unit 236 is a functional unit that registers a document image and registration information that are received from the image forming apparatus. When receiving a request to register a document image, the registration unit 236 generates unique identification information (hereafter, referred to as registered-document-image identification information) on the document image to be registered. The registration unit 236 registers the document image and the registered-document-image identification information in a storage device (not illustrated) of the image management server 130 and registers registration information in the document-image database 240.

According to the present embodiment, the image forming apparatus writes registration information in a structured document that is described in a markup language, such as HTML, XML, or XHTML. The registration unit 236 analyzes the structured document sent from the image forming apparatus so as to extract the registration information and registers the registration information in the document-image database 240. A detailed explanation is given later of the document-image database 240.

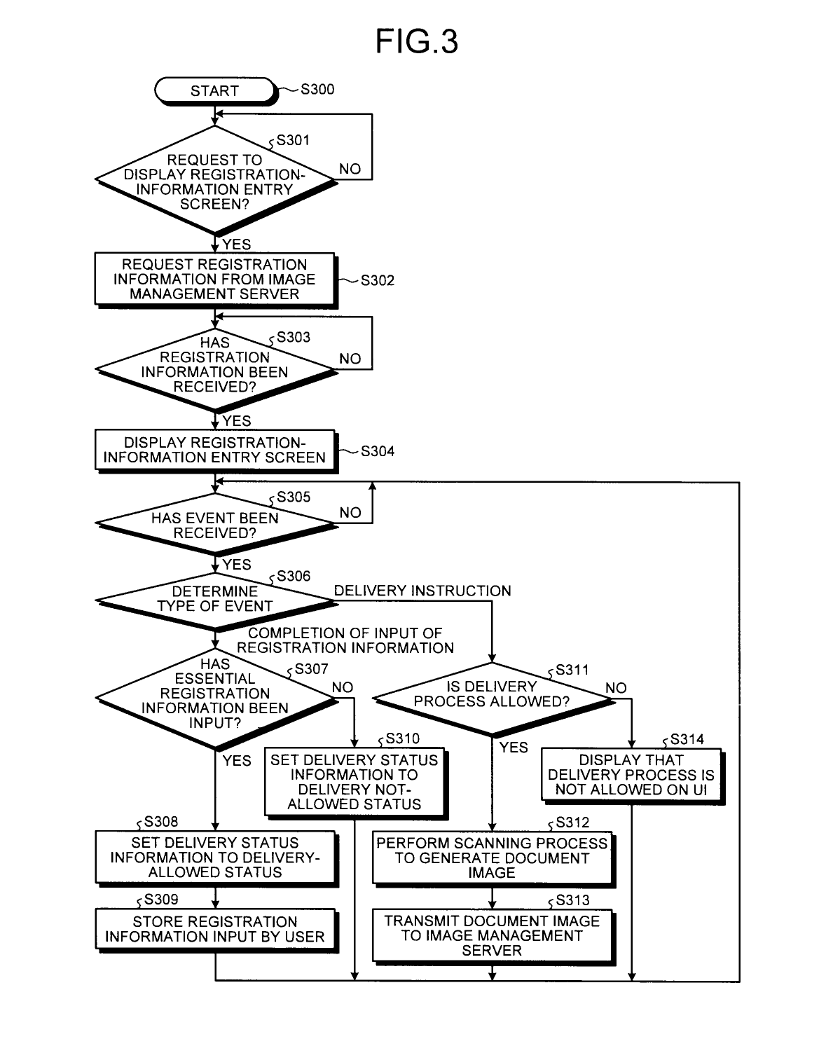

FIG. 3 is a flowchart of a process performed by the image forming apparatus according to the present embodiment. An explanation is given below, with reference to FIG. 3, of a process for delivering a document image and a process for acquiring registration information, both of which are performed by the image forming apparatus 120a.

The process illustrated in FIG. 3 starts at Step S300. At Step S301, the delivery control unit 222 determines whether it has received, from the input receiving unit 210, a request to display the registration-information entry screen, which has been issued due to the user's operation of the image forming apparatus 120a. If it is determined that the request to display the registration-information entry screen has not been received (No), the process at Step S301 is repeated. Conversely, if it is determined that the request to display the registration-information entry screen has been received (Yes), the process proceeds to Step S302.

At Step S302, the delivery control unit 222 calls the registration-information acquiring unit 224 so that the registration-information acquiring unit 224 transmits, to the image management server 130 via the communication control unit 216, a request to acquire registration information and the document-image type information. According to the present embodiment, document-image type information is acquired before a request to display the registration-information entry screen is received, as described above.

At Step S303, the registration-information acquiring unit 224 determines whether the registration information, the essential registration information, and/or the selection information of the registration information have been received from the image management server 130. If it is determined that the registration information, and the like, have not been received (No), the registration-information acquiring unit 224 repeats the process at Step S303. Conversely, if the registration information, and the like, have been received (Yes), the registration-information acquiring unit 224 stores the acquired registration information in the storage device 226. The process proceeds to Step S304.

At Step S304, the delivery control unit 222 causes the display processing unit 212 to display the registration-information entry screen. At Step S305, the delivery control unit 222 determines whether an event has been received from the input receiving unit 210. If an event has not been received (No), the process at Step S305 is repeated. Conversely, if it is determined that an event has been received (Yes), the process proceeds to Step S306. At Step S306, the delivery control unit 222 determines the type of event received at Step S305.

If it is determined at Step S306 that the type of event indicates the completion of input of registration information, the process proceeds to Step S307. At Step S307, the delivery control unit 222 calls the delivery-allowability determining unit 228 so that the delivery-allowability determining unit 228 determines whether the essential registration information has been input by using the registration information stored in the storage device 226 and by using the registration information that has been input by the user and that has been notified of together with the completion of input of the registration information. If it is determined that the essential registration information has been input (Yes), the process proceeds to Step S308 so that the delivery-allowability determining unit 228 sets the delivery status information to the delivery-allowed status. At Step S309, the delivery-allowability determining unit 228 temporarily stores the registration information input by the user in a storage device, such as a RAM. Then, the process returns to Step S305 so as to enter an input wait state again.

Conversely, if it is determined, in the determination at Step S307, that the essential registration information has not been input (No), the process proceeds to Step S310. At Step S310, the delivery-allowability determining unit 228 sets the delivery status information to the delivery not-allowed status. Then, the process at Step S305 is performed.

If it is determined at Step S306 that the type of event indicates a delivery instruction, the process proceeds to Step S311. At Step S311, the delivery control unit 222 determines whether the delivery process is allowed by using the delivery status information. If it is determined that the delivery process is allowed (Yes), the process proceeds to Step S312. At Step S312, the delivery control unit 222 causes the scanner unit 214 to generate a document image. At Step S313, the delivery control unit 222 transmits, to the image management server 130 via the communication control unit 216, the document image and the registration information that is input by the user and is stored in the storage device. Then, the process returns to Step S305 so as to enter an input wait state again.

Conversely, if it is determined, in the determination at Step S311, that the delivery process is not allowed (No), the process proceeds to Step S314. At Step S314, the delivery control unit 222 causes the display processing unit 212 to display, on the UI, that the delivery process is not allowed. Then, the process proceeds to Step S305 so as to enter an input wait state again. In the present embodiment, the delivery control unit 222 causes the display processing unit 212 to display, on the operation panel, that the process for delivering the document image is not allowed and also displays any registration information that needs to be input by a user.

According to the present embodiment, if essential registration information has not been input, the image forming apparatus rejects the process for delivering the document image; however, in another embodiment, the default value is set in the essential registration information stored in the registration-information database 238 of the image management server 130 and, even if the user has not input the essential registration information, the image forming apparatus can register the default value in the image management server 130 as the registration information of a document image to be registered.

FIG. 4 illustrates an embodiment of a registration-information data table that is registered in the registration-information database according to the present embodiment. An explanation is given below of a registration-information data table (a user-information table) 400 with reference to FIG. 4.

Document-image type information 410, registration information 412, essential registration information 414, and selection information of the registration information 416 are registered in the registration-information data table 400 in a related manner.

Type information on a document image to be registered in the image management server 130 is registered in the document-image type information 410. In the embodiment illustrated in FIG. 4, a receipt and an identification card are registered as the document-image type information 410. The value “abc” is assigned as the identification information that indicates the receipt, and the value “def” as the identification information that indicates the identification card. By using these values, the image forming apparatus notifies the image management server of the type of document image to be registered and then acquires the registration information that is related to the type of document image.

In the registration information 412, registration information on a document image to be registered in the image management server 130 is registered for each piece of document-image type information. In the embodiment illustrated in FIG. 4, the purchase date, purchaser, name of purchased goods, price of purchased goods, and purchase purpose are registered as the registration information on the receipt that is a document image to be registered. The value “abcdef”, or the like, is assigned as identification information to each of the pieces of the registration information. Furthermore, these pieces of the registration information are given to the image forming apparatus as character information so that the display processing unit 212 of the image forming apparatus displays, on the operation panel, the character strings “purchase date”, “purchaser”, “name of purchased goods”, “price of purchased goods”, and “purchase purpose” that indicates the above pieces of the registration information.

In the embodiment illustrated in FIG. 4, the type of certificate, name, address (name of city, town, and village, and name of country), and name of company are registered as registration information on the identification card that is a document image to be registered. The value “defghi”, or the like, is assigned as identification information to each of the pieces of the registration information in the same manner as the registration information on the receipt. Furthermore, in the same manner as the registration information on the receipt, these pieces of the registration information are given to the image forming apparatus as character information so as to be displayed on the operation panel.

Essential registration information that is registration information to be always registered in the document-image database 240 is registered in the essential registration information 414. In the embodiment illustrated in FIG. 4, the values “abcdef” and “abcghi” are registered as the essential registration information on the receipt that is a document image to be registered. The values “abcdef” and “abcghi” are identification information that indicate a purchase date and purchaser. The values “defghi” and “defjkl” are registered as the essential registration information on the identification card that is a document image to be registered. The values “defghi” and “defjkl” are identification information that indicate a certificate document and a full name. According to the present embodiment, the image forming apparatus acquires, from the image management server 130, registration information, essential registration information, and selection information for each type of document image and determines whether registration information indicated by essential registration information has been input by a user so as to determine whether the delivery of the document image is allowed.

Selection information of registration information to be displayed on the registration-information entry screen displayed by the image forming apparatus is registered in the selection information of the registration information 416. In the embodiment illustrated in FIG. 4, “driver license”, “health insurance card”, and “foreign registration card” are registered as selection information of the registration information “type of certificate” of the identification card. The value “defghi01”, or the like, is assigned to each of them as identification information. The image forming apparatus is provided with the selection information so that it is displayed as selection information on the registration-information entry screen. A detailed explanation is given later of the registration- information entry screen.

In the present embodiment, the receipt and the identification card are illustrated as an example of identification information that indicates the document-image type information; however, in another embodiment, any type of document image may be used. Furthermore, in another embodiment, identification information that indicates the document-image type information, registration information, or selection information of the registration information may use any character strings or numerical characters or any combination of character strings and numerical characters as long as the identification information is uniquely identifiable.

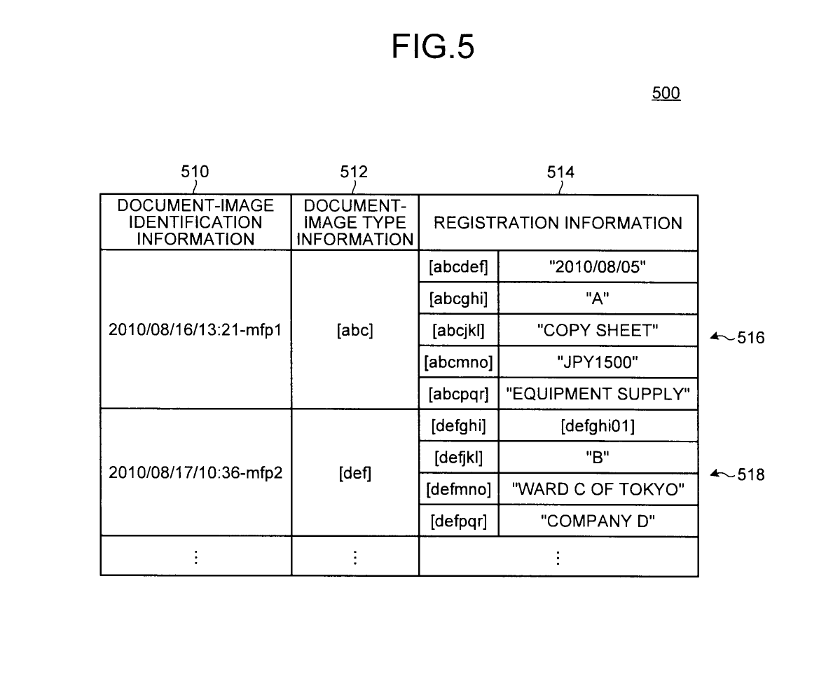

FIG. 5 is a representation that illustrates an embodiment of a document-image data table that is registered in the document-image database according to the present embodiment. An explanation is given below of a document-image data table 500 with reference to FIG. 5.

Document-image identification information 510, document-image type information 512, and registration information 514 are registered in the document-image data table 500 such that they are related to one another.

Identification information on a document image registered in the image management server 130 is registered in the document-image identification information 510. In the embodiment illustrated in FIG. 5, a combination of time stamp information that indicates the receipt time of a document image and of identification information on the image forming apparatus that has transmitted the document image is used as the document-image identification information 510. In another embodiment, any character strings or numerical characters or any combination of character strings and numerical characters may be used as long as the document image is uniquely identifiable.

Document-image type information that indicates the type of document image registered in the image management server 130 is registered in the document-image type information 512. The document-image type information registered in the registration-information data table 400 is used as the document-image type information registered in the document-image data table 500. In the embodiment illustrated in FIG. 5, the document-image type information “abc” that indicates the receipt and the document-image type information “def” that indicates the identification card are registered as the document-image type information 512.

Registration information on a document image registered in the image management server 130 is registered in the registration information 514. The registration information registered in the registration-information data table 400 is used as the registration information registered in the document-image data table 500.

In the registration information 516 according to the embodiment illustrated in FIG. 5, the character string “2010/08/05” that indicates the purchase date is registered in relation to the identification information “abcdef” that indicates the purchase date; the character string “A” that indicates the purchaser is registered in relation to the identification information “abcghi” that indicates the purchaser; the character string “copy sheet” that indicates the name of purchased goods is registered in relation to the identification information “abcjkl” that indicates the name of the purchased goods; the character string “JPY1500” that indicates the price of the purchased goods is registered in relation to the identification information “abcmno” that indicates the price of the purchased goods; and the character string “equipment supply” that indicates the purchase purpose is registered in relation to the identification information “abcpqr” that indicates the purchase purpose.

Furthermore, in registration information 518, the identification information “defghi01” that indicates “driver license” is registered in relation to the identification information “defghi” that indicates selection information on a certificate document; the character string “B” that indicates a full name is registered in relation to the identification information “defjkl” that indicates a full name; the character string “ward C of Tokyo” that indicates an address is registered in relation to the identification information “defmno” that indicates an address; and the character string “company D” that indicates the name of a company is registered in relation to the identification information “defpqr” that indicates the name of a company.

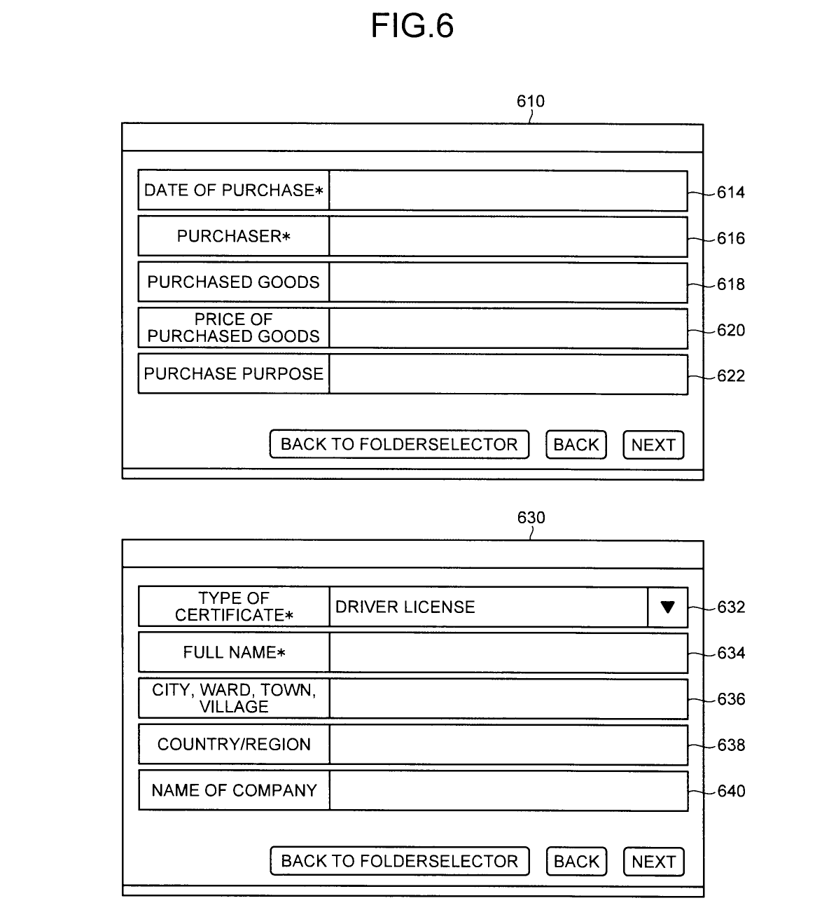

FIG. 6 is a diagram that illustrates the registration-information entry screen that is a UI displayed on the image forming apparatus according to the present embodiment. The image forming apparatus uses registration information, essential registration information, and/or selection information of the registration information, which are received from the image management server 130, so as to display the registration-information entry screen. An explanation is given below of registration-information entry screens 610 and 630 with reference to FIG. 6.

The registration-information entry screen 610 is a registration-information entry screen that is displayed if a document image is a receipt. The registration-information entry screen 610 includes an entry field 614 for inputting the date of purchase, an entry field 616 for inputting the purchaser, an entry field 618 for inputting the purchased goods, an entry field 620 for inputting the price of the purchased goods, and an entry field 622 for inputting the purchase purpose. A user uses a keypad included in the image forming apparatus or a key entry screen, or the like, displayed on the operation panel to input any character strings into these entry fields.

The registration-information entry screen 630 is a registration-information entry screen that is displayed if a document image is an identification card. The registration-information entry screen 630 includes a selection button 632 for selecting the certificate document, an entry field 634 for inputting a full name, an entry field 636 for inputting a city, ward, town, or village, an entry field 638 for inputting a country/region, and an entry field 640 for inputting the name of a company. In the same manner as the registration-information entry screen 610, a user uses a keypad included in the image forming apparatus or a key entry screen, or the like, displayed on the operation panel to input any character strings into these entry fields.

According to the present embodiment, if the user presses the selection button 632, the delivery control unit 222 causes the display processing unit 212 to display selectable certificate documents. If the user selects a selectable certificate document displayed on the registration-information entry screen, the delivery control unit 222 is notified of the certificate document via the input receiving unit 210.

Furthermore, according to the present embodiment, the display processing unit 212 can display the mark “*”, character, symbol, or the like, that indicates something is essential registration information near the entry fields or selection fields for the date of purchase, purchaser, certificate document, and full name, which are the essential registration information.

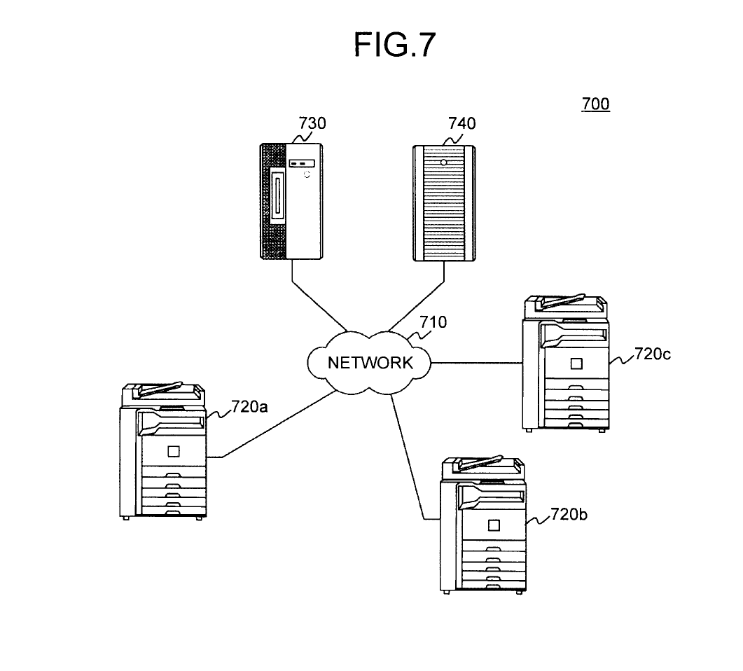

FIG. 7 is a diagram that illustrates an image delivery system 700 according to another embodiment. The image delivery system 700 includes a network 710, image forming apparatuses 720a, 720b, and 720c, an image management server 730, and a delivery management server 740. The image forming apparatuses 720a, 720b, and 720c, the image management server 730, and the delivery management server 740 are connected to the network 710. The image delivery system 700 is different from the image delivery system 100 that has been described with reference to FIG. 1 in that the image delivery system 700 includes the delivery management server 740; however, the image delivery system 700 is similar to the image delivery system 100 in other aspects, and therefore an explanation is mainly given below of the differences between them.

The delivery management server 740 is a server that determines whether a process for delivering a document image by the image forming apparatuses 720a, 720b, and 720c is allowable so as to manage the process for delivering a document image. The delivery management server 740 has a PENTIUM (registered trademark) or compatible processor and, under the control of an OS, such as Windows (registered trademark) 200x Server, UNIX (registered trademark), or LINUX (registered trademark), executes the program according to the present embodiment. The delivery management server 740 includes, for example, a RAM that provides an execution space for executing programs, or an HDD that continuously stores programs and data; thus, the program according to the present embodiment is executed so that the functions described below are performed by the delivery management server 740.

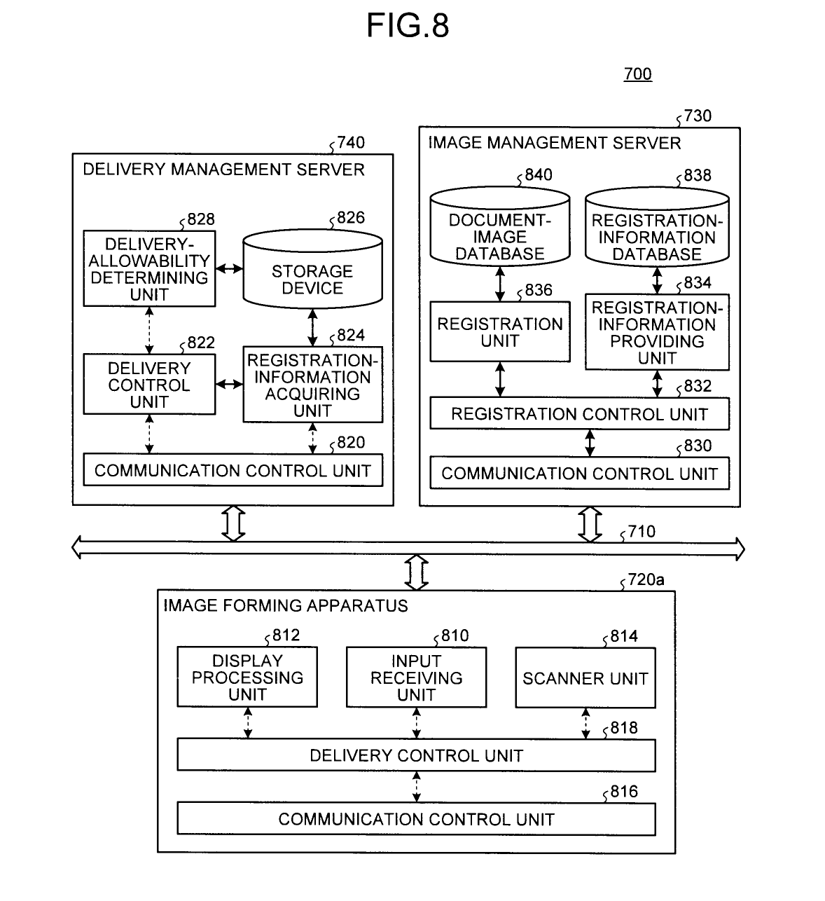

FIG. 8 is a diagram that illustrates the functional configuration of the image forming apparatus 720a, the image management server 730, and the delivery management server 740 included in the image delivery system 700 illustrated in FIG. 7. An explanation is given below, with reference to FIG. 8, of the processing function performed by the delivery management server 740. Because the image management server 730 has the similar configuration as the image management server 130 that has been described with reference to FIG. 2, its detailed explanation is omitted below. Because the image forming apparatus 720a has the similar configuration as the image forming apparatus 120a that has been described with reference to FIG. 2, an explanation is mainly given below of the differences between them. Because the image forming apparatuses 720b and 720c have the similar configuration as the image forming apparatus 720a, their explanations are omitted below.

The delivery management server 740 is an information processing apparatus (a delivery management apparatus) that manages delivery of a document image that is performed by the image forming apparatus via the network 710. The delivery management server 740 includes a communication control unit 820, a delivery control unit 822, a registration-information acquiring unit 824, a storage device 826, and a delivery-allowability determining unit 828.

The communication control unit 820 is a functional unit that transmits and receives data to and from the image forming apparatus 720a and the image management server 730 via the network 710. When receiving, from the image forming apparatus 720a, a request to acquire registration information or a request to determine whether delivery of a document image is allowable, the communication control unit 820 sends a notification to the delivery control unit 822 or the registration-information acquiring unit 824.

When receiving, from the registration-information acquiring unit 824, a request to acquire registration information and document-image type information, the communication control unit 820 transmits the acquisition request and the document-image type information to the image management server 730 and then provides the registration-information acquiring unit 824 with the response data, i.e., the registration information.

When receiving, from the delivery control unit 822, a result of the determination as to whether the delivery of a document image is allowable, the communication control unit 820 transmits the result of the determination to the image forming apparatus.

According to the present embodiment, data that is transmitted and received via the network 710 includes information for identifying a destination and a source; thus, the image forming apparatuses 720a, 720b, and 720c, the delivery management server 740, and the image management server 730, which are nodes of the network 710, can determine the source of received data.

The delivery control unit 822 is a functional unit that controls the functional units included in the delivery management server 740 so as to manage the process for delivering a document image. When receiving, from the image forming apparatus, a request to acquire registration information and receiving document-image type information on a document image to be registered, the delivery control unit 822 calls the registration-information acquiring unit 824 so as to acquire the registration information from the image management server 730. When receiving, from the image forming apparatus, a request to determine whether delivery of a document image is allowable, the delivery control unit 822 calls the delivery-allowability determining unit 828 so as to determine whether delivery of a document image is allowable and then sends the result of the determination to the image forming apparatus.

The registration-information acquiring unit 824 is a functional unit that acquires registration information from the image management server 730. The registration-information acquiring unit 824 transmits, to the image management server 730, a request to acquire registration information and document-image type information that is received from the image forming apparatus so as to acquire registration information, essential registration information, and/or selection information of the registration information that are registered in a registration-information database 838 and is related to the document-image type information. The registration-information acquiring unit 824 transmits, to the image forming apparatus, the registration information, essential registration information, and/or the selection information of the registration information. The registration-information acquiring unit 824 stores, in the storage device 826, the registration information, the essential registration information, and/or the selection information of the registration information such that they are related to the identification information on the image forming apparatus.

The delivery-allowability determining unit 828 is a functional unit that determines whether delivery of a document image is allowable. The delivery-allowability determining unit 828 acquires, from the storage device 826, the essential registration information that is related to the identification information on the image forming apparatus that has transmitted a request to determine whether delivery of a document image is allowable. The delivery-allowability determining unit 828 determines whether the essential registration information is included in the registration information that has been received together with the determination request so as to determine whether delivery of the document image is allowable. The delivery-allowability determining unit 828 notifies the delivery control unit 822 of the result of the determination.

The image forming apparatus 720a includes an input receiving unit 810, a display processing unit 812, a scanner unit 814, a communication control unit 816, and a delivery control unit 818. The input receiving unit 810, the display processing unit 812, the scanner unit 814, and the communication control unit 816 have the similar functions as the input receiving unit 210, the display processing unit 212, the scanner unit 214, and the communication control unit 216, respectively, which have been explained with reference to FIG. 2; therefore, their explanations are omitted below.

The delivery control unit 818 is a functional unit that controls the display processing unit 812 and the scanner unit 814 so as to perform the process for delivering a document image. When receiving, from the input receiving unit 810, a request to display the registration information screen, the delivery control unit 818 transmits, to the delivery management server 740, a request to acquire registration information together with document-image type information. The delivery control unit 818 then uses registration information, essential registration information, and selection information of the registration information that have been received from the delivery management server 740 so as to cause the display processing unit 812 to display the registration-information entry screen.

According to the present embodiment, in the same manner as the embodiment described with reference to FIG. 2, the operation panel displays a UI for designating a method for delivering a document image and designating information on a delivery destination. A user uses the UI to designate a method for delivering a document image, information on a delivery destination, and document-image type information and then sends a request to display the registration-information entry screen; thus, the registration-information entry screen is displayed.

When receiving an event that commands the execution of the process for delivering a document image after registration information is input through the registration-information entry screen by the user, the delivery control unit 818 transmits, to the delivery management server 740, a delivery-allowability determination request and the registration information so as to cause the delivery management server 740 to determine whether the delivery of a document image is allowable. When receiving, from the delivery management server 740, a reply indicating that the delivery of the document image is allowed, the delivery control unit 818 causes the scanner unit 814 to generate a document image and transmits the document image to the image management server 730 for registration. Conversely, when receiving a reply indicating that the delivery of the document image is not allowed, the delivery control unit 818 causes the display processing unit 812 to display that indication.

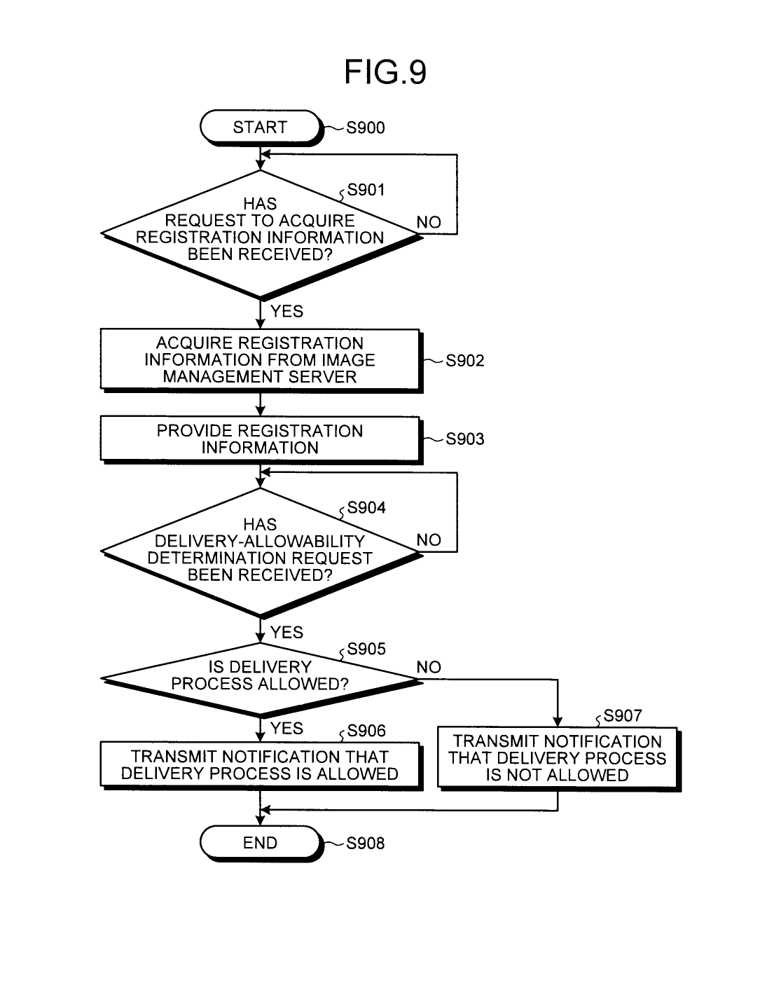

FIG. 9 is a diagram that illustrates a flowchart of a process performed by the delivery management server according to another embodiment. An explanation is given below, with reference to FIG. 9, of a process performed by the delivery management server 740.

The process illustrated in FIG. 9 starts at Step S900. At Step S901, the delivery control unit 822 determines whether a request to acquire registration information has been received. If it is determined that a request to acquire registration information has not been received (No), the process at Step S901 is repeated. Conversely, if it is determined that a request to acquire registration information has been received (Yes), the process proceeds to Step S902.

At Step S902, the delivery control unit 822 calls the registration-information acquiring unit 824 so that the registration-information acquiring unit 824 transmits, to the image management server 730, the request to acquire registration information and the document-image type information so as to acquire, from the registration-information database 838, the registration information, the essential registration information, and/or the selection information of the registration information that are related to the document-image type information. At Step S903, the registration-information acquiring unit 824 provides the image forming apparatus with the registration information, the essential registration information, and/or the selection information of the registration information.

At Step S904, the delivery control unit 822 determines whether a request to determine whether delivery is allowable has been received from the image forming apparatus. If the request to determine whether delivery is allowable has not been received (No), the process at Step S904 is repeated. Conversely, if it is determined that the request to determine whether delivery is allowable has been received (Yes), the process proceeds to Step S905. At Step S905, the delivery control unit 822 calls the delivery-allowability determining unit 828 so that the delivery-allowability determining unit 828 determines whether the image forming apparatus, which has transmitted the delivery-allowability determination request, is allowed to perform the process for delivering a document image. If it is determined that the delivery process is allowed (Yes), the process proceeds to Step S906. At Step S906, the delivery control unit 822 transmits, to the image forming apparatus, a notification that the delivery process is allowed, and then the process at Step S908 is terminated.

Conversely, if it is determined, in the determination at Step S905, that the delivery process is not allowed (No), the process proceeds to Step S907. At Step S907, the delivery control unit 822 transmits, to the image forming apparatus, a notification that the delivery process is not allowed, and the process at Step S908 is terminated.

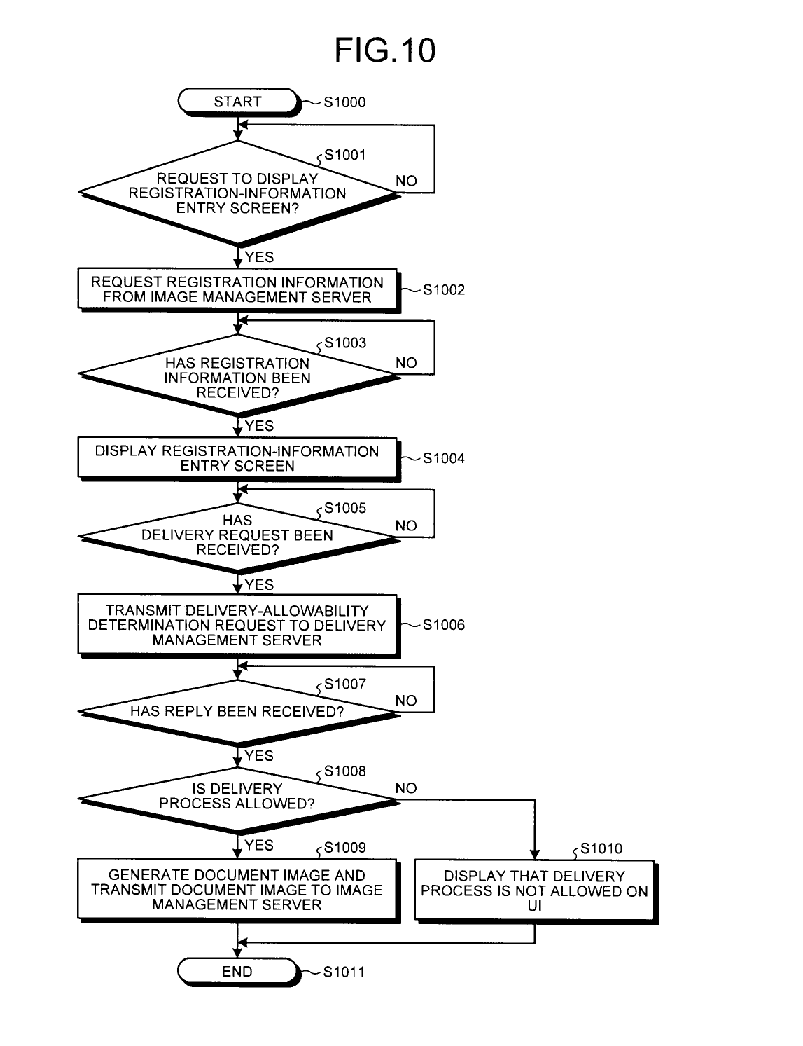

FIG. 10 is a diagram that illustrates a flowchart of a process performed by the image forming apparatus according to another embodiment. An explanation is given below, with reference to FIG. 10, of a process performed by the image forming apparatus 720a.

The process illustrated in FIG. 10 starts at Step S1000. At Step S1001, the delivery control unit 818 determines whether it has received, from the input receiving unit 810, a request to display the registration-information entry screen, which has been issued due to the user's operation of the image forming apparatus 720a. If it is determined that the request to display the registration-information entry screen has not been received (No), the process at Step S1001 is repeated. Conversely, if it is determined that the request to display the registration-information entry screen has been received (yes), the process proceeds to Step S1002.

At Step S1002, the delivery control unit 818 transmits, to the delivery management server 740 via the communication control unit 816, a request to acquire registration information and transmits document-image type information. According to the present embodiment, document-image type information is acquired before a request to display the registration-information entry screen is received.

At Step S1003, the delivery control unit 818 determines whether registration information, essential registration information, and/or selection information of the registration information have been received from the delivery management server 740. If it is determined that the registration information, and the like, have not been received (No), the delivery control unit 818 repeats the process at Step S1003. Conversely, if the registration information, and the like, have been received (Yes), the process proceeds to Step S1004. At Step S1004, the delivery control unit 818 causes the display processing unit 812 to display the registration-information entry screen.

At Step S1005, the delivery control unit 818 determines whether it has received, from the input receiving unit 810, an event that commands the execution of the delivery process. If the event has not been received (No), the process at Step S1005 is repeated. Conversely, if it is determined that the event has been received (Yes), the process proceeds to Step S1006. At Step S1006, the delivery control unit 818 transmits, to the delivery management server 740, a request to determine whether delivery is allowable.

At Step S1007, the delivery control unit 818 determines whether a reply has been received from the delivery management server 740 in response to the delivery-allowability determination request. If a reply has not been received (No), the process at Step S1007 is repeated. Conversely, if a reply has been received (Yes), the process proceeds to Step S1008.

At Step S1008, the delivery control unit 818 determines whether the details of the reply indicate that the process for delivering the document image is allowed. If it is determined that the delivery process is allowed (Yes), the process proceeds to Step S1009. At Step S1009, the delivery control unit 818 causes the scanner unit 814 to generate a document image and then transmits the document image to the image management server 730. Then, the process is terminated at Step S1011.

Conversely, if it is determined, in the determination at Step S1008, that the delivery process is not allowed (No), the process proceeds to Step S1010. At Step S1010, the delivery control unit 818 causes the display processing unit 812 to display, on a UI, that the delivery process is not allowed. Then, the process is terminated at Step S1011.

Therefore, it is possible to reliably register information required to search for a document image registered in the image management server. Thus, a process, such as viewing, printing, or updating, can be properly performed on all registered document images.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus that delivers an image of a document, the image forming apparatus comprising:
a registration-information acquiring unit that acquires registration information that is to be registered in an image management apparatus together with the image of the document;
a delivery-allowability determining unit that determines whether delivery of the image of the document is allowable by using the registration information and registration information on the image of the document that is input by a user;
a scanning unit that scans a document so as to generate an image of the document if it is determined that delivery of the image of the document is allowed; and
a delivery control unit that delivers, to the image management apparatus, the image of the document generated by the scanning unit and the registration information input by the user.

2. The image forming apparatus according to claim 1, wherein the registration-information acquiring unit transmits, to the image management apparatus to which the image of the document is to be registered, information that indicates a type of the image of the document so as to acquire registration information that is registered, in a registration-information database of the image management apparatus, in relation to the information that indicates the type of the image of the document.

3. The image forming apparatus according to claim 1, wherein, if the delivery-allowability determining unit determines that delivery of the image of the document is not allowed, the delivery-allowability determining unit provides a user with registration information to be input.

4. An image delivery system comprising:
an image forming apparatus that delivers an image of a document; and
an image management apparatus that registers an image of a document that is delivered by the image forming apparatus,
the image forming apparatus including
a registration-information acquiring unit that acquires registration information that is to be registered in the image management apparatus together with the image of the document;
a delivery-allowability determining unit that determines whether delivery of the image of the document is allowable by using the registration information and registration information on the image of the document that is input by a user;
a scanning unit that scans a document so as to generate an image of the document if it is determined that delivery of the image of the document is allowed; and
a delivery control unit that delivers, to the image management apparatus, the image of the document generated by the scanning unit and the registration information input by the user, and
the image management apparatus including
a registration control unit that provides the registration information; and
a registration unit that registers the image of the document and the registration information input by the user.

5. The image delivery system according to claim 4, wherein the registration-information acquiring unit transmits, to the image management apparatus to which the image of the document is to be registered, information that indicates a type of the image of the document so as to acquire registration information that is registered, in a registration-information database of the image management apparatus, in relation to the information that indicates the type of the image of the document.

6. The image delivery system according to claim 4, wherein, if the delivery-allowability determining unit determines that delivery of the image of the document is not allowed, the delivery-allowability determining unit provides a user with registration information to be input.

7. A delivery management apparatus that manages delivery of an image of a document that is generated by an image forming apparatus, the delivery management apparatus comprising:
a registration-information acquiring unit that acquires registration information that needs to be registered in an image management apparatus together with the image of the document;
a delivery-allowability determining unit that determines whether delivery of the image of the document is allowable by using the registration information and registration information on the image of the document that is input by a user by using the image forming apparatus; and
a communication control unit that notifies, if it is determined that the delivery of the image of the document is allowed, the image forming apparatus that the delivery of the image of the document is allowed.
